(19) United States
(12) Patent Application Publication
(10) Pub. No.: US 2026/0047541 A1
(43) Pub. Date: Feb. 19, 2026

(54) Movable Washing Robot; Method for Cleaning an Animal Stall

(71) Applicant: BEG Schulze Bremer GmbH, Coesfeld (DE)

(72) Inventor: Christian Johannes Schulze Bremer, Dülmen-Rorup (DE)

(21) Appl. No.: 19/101,260

(22) PCT Filed: Aug. 16, 2023
(86) PCT No.: PCT/DE2023/100604

§ 371 Date: Feb. 5, 2025

(30) Foreign Application Priority Data
Aug. 31, 2022 (DE) 10 2022 121 960.7

(51) Int. Cl. A01K 1/01; B05B 13/04; B05B 15/652; G01S 13/88

(52) U.S. Cl. CPC A01K 1/01; B05B 13/0431; B05B 15/652; G01S 13/881

(57) ABSTRACT

A mobile washing robot and a method of cleaning a stable, wherein the mobile washing robot has a chassis, at least one drive mechanism, an undercarriage, at least one cleaning arm, and a computer control unit, with at least one radar sensor by means of which the dimensions of a stable area to be cleaned are automatically measured and/or obstacle detection is automatically performed. Data thus obtained is automatically made available to the computer control unit for calculating a position of at least one cleaning arm and a travelling speed, a position of at least one nozzle head, a position of at least one nozzle, an activation/deactivation of at least one nozzle and/or a flow rate of a fluid within a nozzle, so that a user does not have to perform any teach-in procedure with regard to the stable area to be cleaned, making savings in personnel costs possible.

### CROSS REFERENCE TO RELATED APPLICATIONS

This application is the U.S. national stage of International Application No. PCT/DE2023/100604, filed on 2023-8-16. The international application claims the priority of DE 102022121960.7 filed on 2022-8-31; all applications are incorporated by reference herein in their entirety.

### BACKGROUND

### Prior Art

The invention is based on a mobile washing robot according to the preamble of claim 1 and on a method of cleaning a stable according to the preamble of claim 11.

Stables, in particular pigsties, are thoroughly cleaned for hygiene-related reasons at the latest after each breeding cycle. This cleaning work is typically carried out manually by a person using a high-pressure cleaner. The disadvantage here is that cleaning a stable is strenuous, time-consuming, unpleasant and possibly harmful to health due to dirt, moisture, odours, ammonia emissions and germs.

In order to overcome these disadvantages, washing robots have been in use for some time to perform these stable cleaning tasks. In the course of this process, a washing robot will typically move at a slow pace along the stable corridor, such that a cleaning fluid is sprayed at high pressure on one side or on both sides thereof into the boxes that are to be cleaned by means of long cleaning arms fitted with nozzles. The disadvantage here is that these washing robots do not recognise obstacles such as supports or pipes, so that they cannot be used in all types of stable, and that the joints are susceptible to developing faults or defects. Furthermore, a user has to carry out manual rework, as these washing robots are of a simple design where only one nozzle position is specified, which means that components in the stable will receive the washing jet only from one point.

In order to overcome this disadvantage, patent specification DE 699 32 455 T2 proposes a cleaning device for animal stables which comprises a chassis having two pairs of wheels at least one of which being drivable by means of a driving device connected thereto and a nozzle part connected to a cleaning fluid supply for delivering a jet of cleaning fluid, wherein a cleaning arm which is movably attached to the chassis by means of a joint and on which the nozzle part is movably connected to the outer end of said cleaning arm has joint means which are provided with position and/or movement registration means for determining the position of the cleaning arm as a function of time and which are further provided with drive means for setting the cleaning arm in motion, and wherein the cleaning device is further provided with a programmable control unit which has inputs for receiving signals from the position and/or movement registration means, means for determining parking positions, a memory for storing the signals in the form of a programme, and outputs for sending control signals, such that both the drive wheels and the movements of the cleaning arm and of the nozzle part may be controlled. The disadvantage here is that the cleaning device, when used for the first time, has to be laboriously programmed for each box by a user by initiating a teach-in procedure in the course of which the user manually controls the cleaning device during the cleaning of a box.

Furthermore, the published applications CN 113 934 215 A, ES 2 891 401 A1, CN 113 678 741 A and the utility model specification CN 213 589 221 U1 disclose cleaning devices for animal stables which have radar sensors for monitoring the travel paths of the cleaning devices. The disadvantage with all these approaches is that they still require a teach-in procedure.

### SUMMARY

A mobile washing robot (1) and a method of cleaning a stable are proposed, wherein the inventive mobile washing robot (1) which has a chassis (2), at least one drive mechanism, an undercarriage, at least one cleaning arm (6) (wherein for delivering at least one fluid, at least one cleaning arm (6) has at least one nozzle head (8) including at least one nozzle (7) arranged thereon), and a computer control unit, has at least one radar sensor (24) by means of which the dimensions of a stable area to be cleaned are automatically measured and/or an obstacle detection is automatically carried out, whereby data thus obtained are automatically made available to the computer control unit for calculating a position of at least one cleaning arm (6) and for calculating a travelling speed, a position of at least one nozzle head (8), a position of at least one nozzle (7), an activation and deactivation of at least one nozzle (7) and/or a flow rate of a fluid within at least one nozzle (7), so that a user does not have to submit the inventive mobile washing robot (1) to any teach-in procedure with regard to the stable area to be cleaned, which makes it possible, among other things, to achieve savings in personnel costs.

### DETAILED DESCRIPTION

It is therefore an object of the invention to provide a mobile washing robot that overcomes the disadvantages of the state of the art and to provide a method of cleaning a stable which overcomes the disadvantages of the state of the art.

### THE INVENTION AND ITS ADVANTAGES

The inventive mobile washing robot having the features of claim 1 and the inventive method of cleaning a stable having the features of claim 11, have, in contrast, the advantage that the inventive mobile washing robot which has a chassis, at least one drive mechanism, an undercarriage, at least one sensor for travel path monitoring at least one cleaning arm (wherein for delivering at least one fluid, at least one cleaning arm has at least one nozzle head including at least one nozzle arranged thereon), and a computer control unit, has (in addition to the at least one sensor for travel path monitoring) at least one further radar sensor by means of which the dimensions of a stable area to be cleaned are automatically measured and/or an obstacle detection is automatically carried out, whereby data thus obtained are automatically made available to the computer control unit for calculating a position of at least one cleaning arm and for calculating a travelling speed, a position of at least one nozzle head, a position of at least one nozzle, an activation and deactivation of at least one nozzle and/or a flow rate of a fluid within at least one nozzle, so that a user does not have to submit the inventive mobile washing robot to any teach-in procedure with regard to the stable area to be cleaned, which makes it possible, among other things, to achieve savings in personnel costs.

According to an advantageous configuration of the inventive mobile washing robot, at least one cleaning arm is movably arranged on the chassis and/or at least one nozzle head arranged on a cleaning arm is movably arranged on said cleaning arm and/or at least one nozzle arranged on a cleaning arm is movably arranged on said cleaning arm.

According to an additional advantageous configuration of the inventive mobile washing robot, at least one drive mechanism and/or at least one cleaning arm and/or at least one nozzle head and/or at least one nozzle may be controlled by the computer control unit.

According to an additional advantageous configuration of the inventive mobile washing robot, at least one cleaning arm consists of several parts and/or can be shortened and/or is foldable.

According to an additional advantageous configuration of the inventive mobile washing robot, at least one cleaning arm is a telescopic arm or a pantograph arm. According to an additional advantageous configuration of the inventive mobile washing robot, said washing robot has at least one guide roller.

According to an additional advantageous configuration of the inventive mobile washing robot, said washing robot has at least one sensor. Preferably, at least one sensor is an ultrasonic sensor.

According to an additional advantageous configuration of the inventive mobile washing robot, said washing robot has a display and/or an operating panel.

According to an additional advantageous configuration of the inventive mobile washing robot, said washing robot has a high-pressure cleaning device and/or a connector for such a high-pressure cleaning device.

According to an additional advantageous configuration of the inventive mobile washing robot, said washing robot has at least one soaking nozzle and/or at least one baffle device for atomising a nozzle's fluid jet. Preferably, the baffle device (e.g. a rod or a tube) is arranged on a cleaning arm or on a nozzle head. As a result, the conversion of the nozzle into a soaking nozzle can preferably be performed automatically, in particular controlled by the computer control unit, so that the installation of a soaking nozzle in the inventive mobile washing robot and a corresponding, valve-operated switching to the soaking nozzle can be omitted. According to an additional advantageous configuration of the inventive mobile washing robot, at least one drive mechanism is an electric drive or a pneumatic motor. The electric drive is preferably battery-operated. If a rechargeable battery is used, continuous operation may be ensured, comparable to a wired supply. If a pneumatic motor is used, the inventive mobile washing robot is connected to a pneumatic hose.

According to an advantageous configuration of the inventive method of cleaning a stable using a mobile washing robot which has a chassis, at least one drive mechanism, an undercarriage, at least one sensor for travel path monitoring, at least one cleaning arm (wherein for delivering at least one fluid, at least one cleaning arm has at least one nozzle head including at least one nozzle arranged thereon), and a computer control unit, wherein said washing robot has, in addition to the at least one sensor for travel path monitoring, at least one radar sensor by means of which the dimensions of a stable area to be cleaned are automatically measured and/or an obstacle detection is automatically carried out, whereby data thus obtained are automatically made available to the computer control unit for calculating a travelling speed, a position of at least one cleaning arm and for calculating a travelling speed, a position of at least one nozzle head, a position of at least one nozzle, an activation and deactivation of at least one nozzle and/or a flow rate of a fluid within at least one nozzle, said computer control unit, when calculating the travelling speed, the position of at least one cleaning arm and when calculating the travelling speed, the position of at least one nozzle head, the position of at least one nozzle, an activation and deactivation of at least one nozzle and/or a flow rate of a fluid within at least one nozzle, takes into account also manually entered data by a user (e.g. the outer wall height to be cleaned, the partition wall height to be cleaned (e.g. box separation), the speed correction, the degree of soiling), in addition to the data automatically provided by the at least one radar sensor in order to calculate the travelling speed, the position of at least one cleaning arm, the position of at least one nozzle head, the position of at least one nozzle, an activation and deactivation of at least one nozzle and/or a flow rate of a fluid within at least one nozzle.

According to a pertinent advantageous configuration of the inventive method, said manually entered data relate to at least one wall height to be cleaned and/or to the degree of soiling.

According to an additional advantageous configuration of the inventive method, the computer control unit uses the data available in order to calculate a position of at least one cleaning arm that varies during cleaning and a travelling speed that varies during the cleaning operation, a position of at least one nozzle head that varies during cleaning, a position of at least one nozzle that varies during cleaning, an activation and deactivation of at least one nozzle that varies during cleaning and/or a flow rate of a fluid within at least one nozzle that varies during cleaning. According to an additional advantageous configuration of the inventive method, the surface to be cleaned is soaked with a fluid before the actual cleaning takes place, the fluid to be dispensed for this purpose being dispensed through at least one soaking nozzle arranged on the washing robot. A soaking programme is preferably started for this purpose. The utilisation of at least one such soaking nozzle eliminates the need to equip the stable with a stationary soaking system including soaking nozzles.

According to an additional advantageous configuration of the inventive method, the atomisation of the fluid to be dispensed is carried out by moving the nozzle head and/or the nozzle and/or the baffle device into such a position that the fluid jet of the nozzle atomises at the baffle device. The fluid jet (high-pressure jet) is thus converted from a point jet into a wide distribution and a spray mist is created instead of a point. This turns the nozzle into a soaking nozzle if required. This means that the soaking process can be carried out in a very water-efficient manner. A soaking programme is preferably started for this purpose. The utilisation of at least one such nozzle cooperating with a baffle device eliminates the need to equip the stable with a stationary soaking system including soaking nozzles.

According to an additional advantageous configuration of the method of the invention, the washing robot employed is a washing robot as claimed in any one of claims 1 to 10.

Further advantages and advantageous configurations of the invention may be found in the following description and in the drawings.

### BRIEF DESCRIPTION OF THE DRAWINGS

Preferred embodiment examples of the object of the invention are represented in the drawings and will be described hereunder in greater detail. In the drawings:

FIG. 1 is a perspective view of an inventive mobile washing robot,

FIG. 2 is another perspective view of the inventive mobile washing robot according to FIG. 1,

FIG. 3 is a side view of the inventive mobile washing robot according to FIG. 1,

FIG. 4 is another side view of the inventive mobile washing robot according to FIG. 1,

FIG. 5 is a view of the rear side of the inventive mobile washing robot according to FIG. 1,

FIG. 6 is a top view of the inventive washing robot according to FIG. 1,

FIG. 7 is a view of the rear side of the inventive mobile washing robot according to FIG. 1, with a retracted and an extended cleaning arm, for illustrative purposes,

FIG. 8 is a perspective detail view of the nozzle head of the inventive mobile washing robot according to FIG. 1,

FIG. 9 is a detail view of one side of the nozzle head of the inventive mobile washing robot according to FIG. 1, and

FIG. 10 is a detail view of the front of the nozzle head of the inventive mobile washing robot according to FIG. 1.

### DETAILED DESCRIPTION OF THE PREFERRED EMBODIMENTS

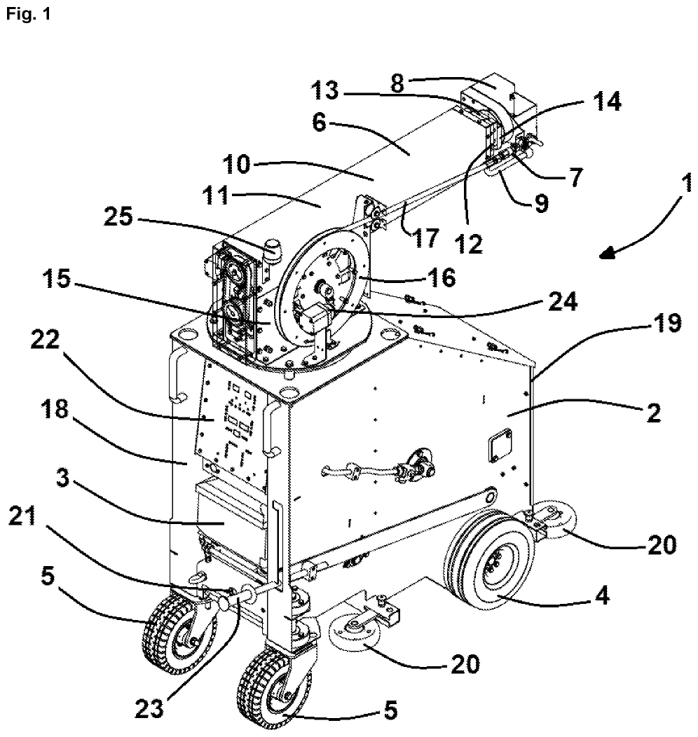

FIG. 1 shows a perspective view of an inventive mobile washing robot 1. The inventive washing robot 1, which serves for the automatic cleaning of stables, especially pigsties, has a chassis 2 preferably made of stainless steel so as to ensure a long service life, a drive mechanism designed as an electric drive and operated using exchangeable batteries 3, an undercarriage having drive wheels 4 (e.g. heavy-duty solid rubber wheels that are robust and fail-safe) and caster wheels 5, with at least one caterpillar system being also conceivable, a cleaning arm 6, said cleaning arm 6 having a nozzle head 8 including a nozzle 7 as well as a baffle device 9 arranged thereon, and a computer control unit.

The cleaning arm 6 is a telescopic arm 10 which is formed of four telescoping elements, i.e. a telescoping element 11, a telescoping element 12, a telescoping element 13, and a telescoping element 14. The cleaning arm 6 is rotatably arranged on the chassis 2 via a turret 15. The turret 15 has a hose reel 16 arranged thereon from which a hose line 17 is automatically unrolled so as to convey fluid to the nozzle 7 when the telescopic arm 10 is extended and/or on which a hose line 17 can automatically be rolled up when the telescopic arm 10 is retracted.

Adjustable guide rollers 20 are arranged on the chassis 2 which has a rear side 18 and a front side 19, so that during operation the inventive washing robot 1 can, for example, slide along a non-illustrated wall. Sensors 21 (ultrasonic sensors) are arranged at the rear side 18 and at the front side 19 to monitor the travel path and automatically detect the end wall of the stable.

The chassis 2 has a large hose reel arranged therein which is connected to the hose reel 16 via a line and from which the hose line can be unwound for establishing a connection to the high-pressure device via a long hose line. The hose reel is driven by the drive mechanism so that the hose line can be automatically unwound during operation or, for example, wound up when reversing during an obstacle wash. The hose reel is dimensioned sufficiently large that long hose lines can be accommodated so that, for example, stables having a length of 80 metres can also be cleaned.

A non-illustrated user can start up the inventive washing robot 1 via a simple and intuitive operating display 22. In addition to switching on the inventive washing robot 1, the manual locking means 23 of the drive mechanism is released for this purpose. A timer programme also enables delayed start-up, so that the start will, for example, take place in 5 hours.

After start-up, the cleaning arm 6 uses radar sensors 24 arranged thereon to automatically measure the stable depth and/or the box depth. Using the data obtained in this process, a computer calculates the ideal settings for the nozzle 7 (high-pressure nozzle) and for the telescopic arm 10, which can be telescoped into the boxes by up to 2.70 metres, so that boxes having a depth of up to 7 metres can also be washed. In addition, the radar sensors 24 detect obstacles such as feed outlets, supports or water pipes, so that conversion works in the stable are not necessary and the inventive washing robot 1 can be used in different types of stables, in particular also in farrowing sections which include many obstacles, since the telescopic arm 10 and the nozzle 7 can automatically avoid detected obstacles.

Due to the nozzle head 8 pivotally arranged on the telescopic arm 10 and to the nozzle 7 pivotally arranged on the nozzle head, the inventive washing robot 1 washes the stable construction from different sides and thus produces an optimal washing result. The inventive, fully electric washing robot 1 which for safety reasons is equipped with a signal lamp 25, is powered by the exchangeable battery 3. Basically, no settings need to be made manually, so nothing needs to be saved or programmed. Status messages can be configured or received via a smartphone. For example, the inventive washing robot 1, which retracts the cleaning arm 6 once the cleaning operation has been accomplished and pivots it to a position above the chassis 2, can send a message about the successfully accomplished cleaning to a smartphone once the cleaning operation has been completed.

The inventive washing robot 1 which has a preferred width of only 55 cm and can thus also travel in very narrow corridors, takes over up to 90% of the cleaning work, depending on the circumstances, so that the vast majority of the dirt has already been rinsed away by the inventive washing robot 1 and the remaining subsequent cleaning work is minimised to a very small part and thus becomes much more pleasant. This will save time and increase employee satisfaction. It is also possible to run an automatic soaking programme. In addition to the data automatically determined by the radar sensors 24, a non-illustrated user can also enter additional data, e.g. data on the outer wall height to be cleaned, data on the partition wall height to be cleaned (e.g. box partitions), data relating to a speed correction and/or data on the degree of soiling.

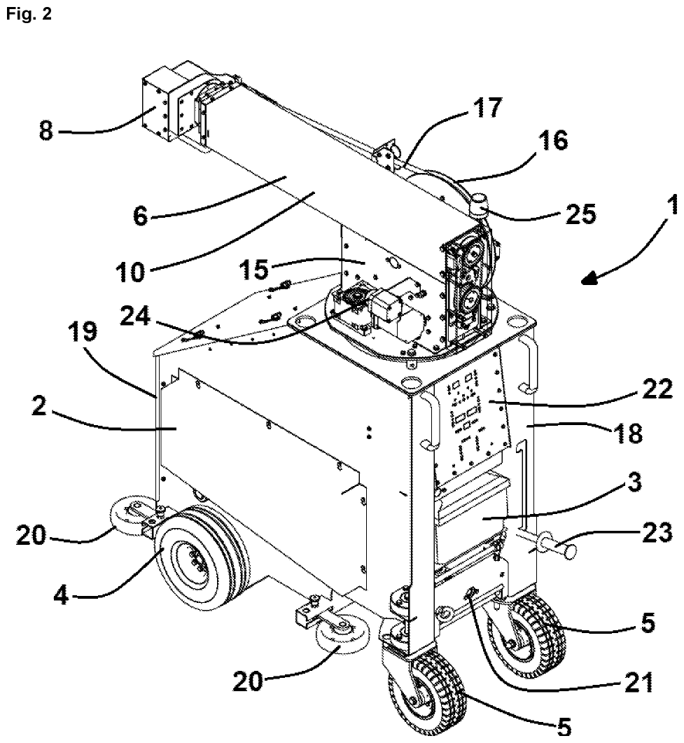

FIG. 2 shows another perspective view of the inventive mobile washing robot 1 according to FIG. 1.

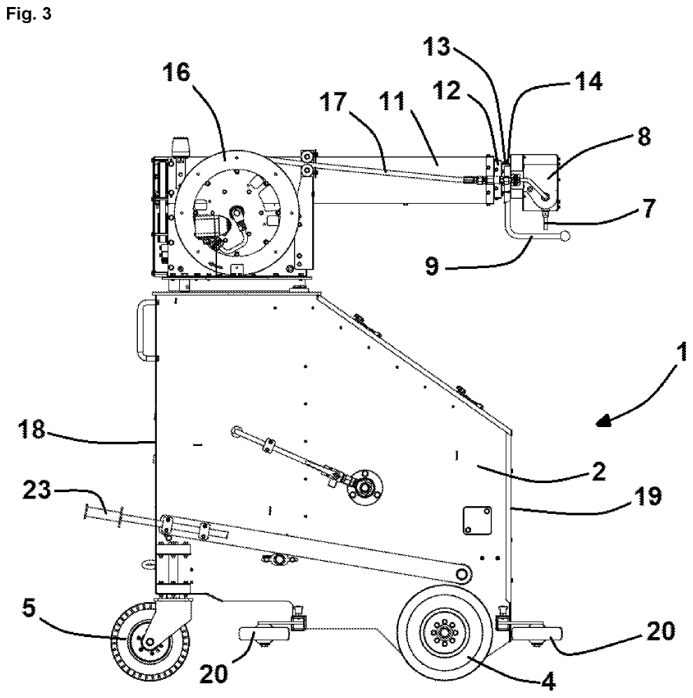

FIG. 3 shows a side view of the inventive mobile washing robot 1 according to FIG. 1.

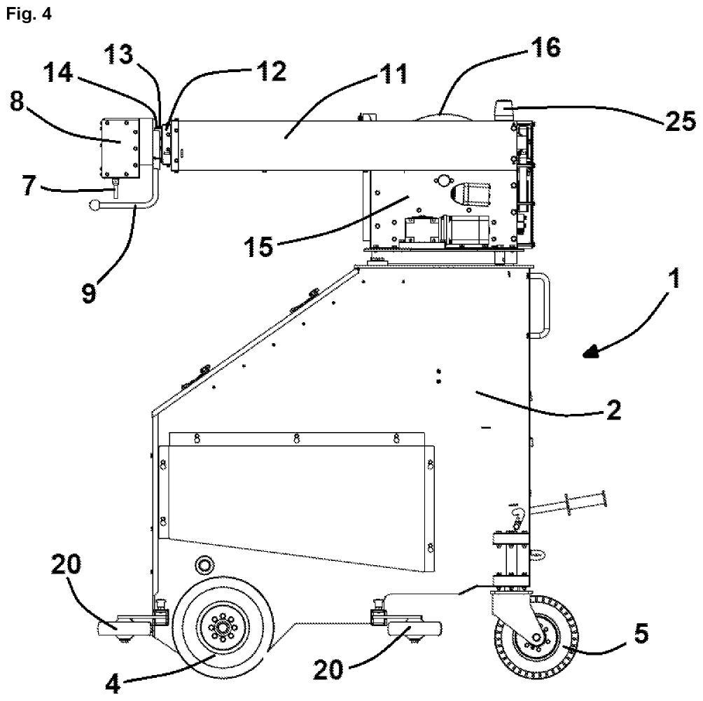

FIG. 4 shows another side view of the inventive mobile washing robot 1 according to FIG. 1.

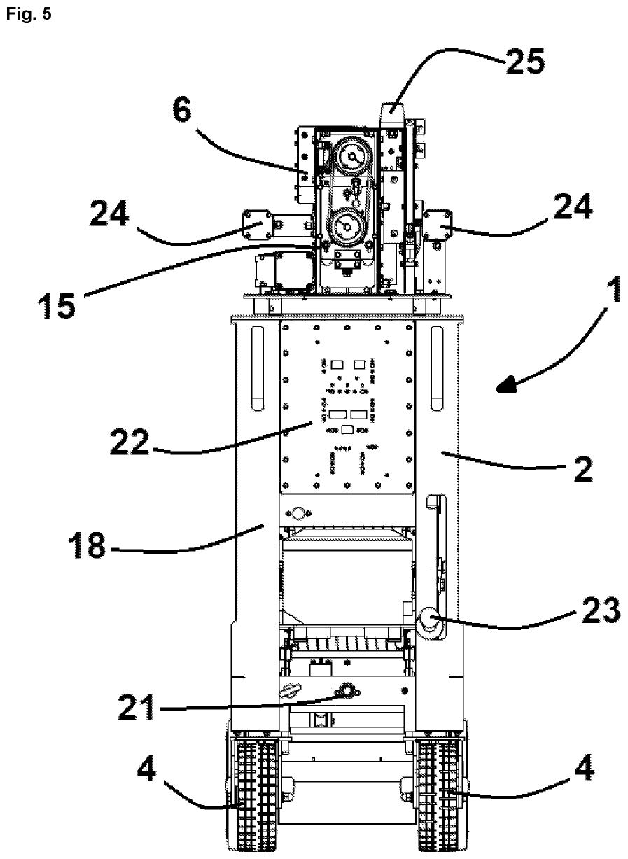

FIG. 5 shows a view of the rear side 18 of the inventive mobile washing robot 1 according to FIG. 1.

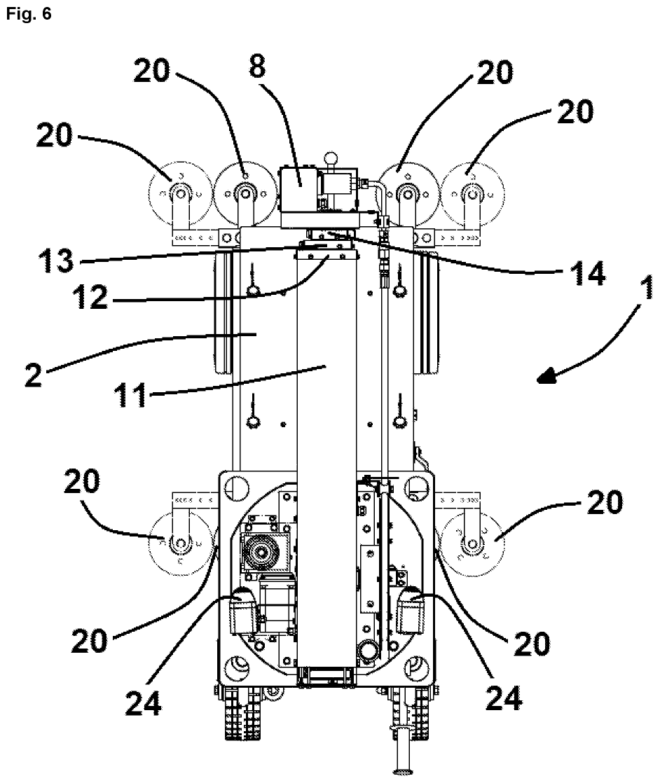

FIG. 6 shows a top view of the inventive mobile washing robot 1 according to FIG. 1. In order to illustrate the adjustment options for the guide rollers 20, these are each shown in two different positions.

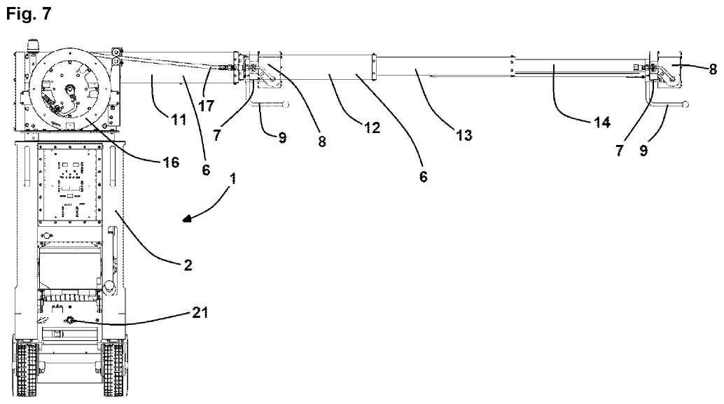

FIG. 7 shows a view of the rear side 18 of the inventive mobile washing robot 1 according to FIG. 1, with a retracted and an extended cleaning arm 6, for illustrative purposes, The pivoting nozzle head 8 rotates to different positions during the washes, so that it is rotated by an angle of 15°for a floor wash, for example, and by 40°for a wall wash (i.e. turned more towards the stable construction). In the event of obstacles and at the compartment end, the nozzle head 8 pivots automatically so that all parts of the box are cleaned.

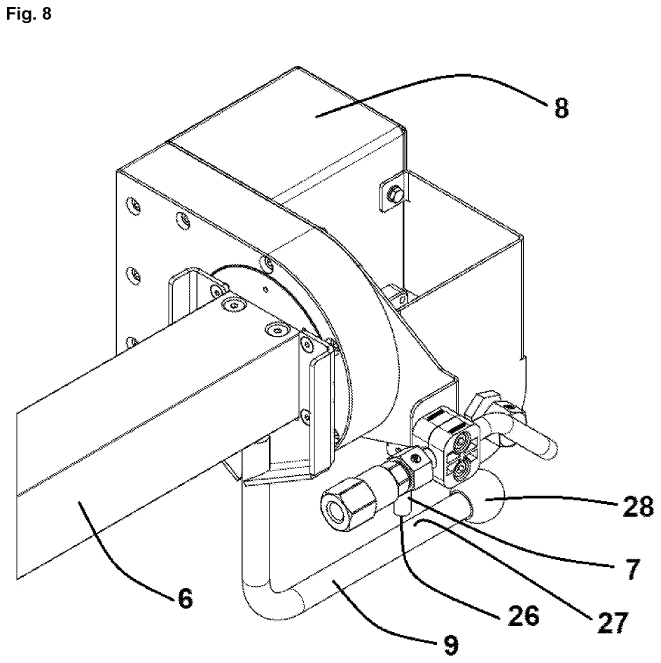

FIG. 8 shows a perspective detail view of the nozzle head 8 of the inventive mobile washing robot 1 according to FIG. 1. In order for an automatic soaking programme to be run, the nozzle 7 provided with a nozzle opening 26 and the baffle device 9 provided with a baffle surface 27, which is shown, by way of example, as a tube and has an injury protection 28 for the non-illustrated user, are positioned relative to each other in such a way that the non-illustrated fluid jet which is ejected from the nozzle opening 26, impinges at least partially on the baffle surface 27, thus causing atomisation of the fluid jet which is necessary for soaking. This allows the inventive washing robot 1 to move swiftly forward through the stable as it undergoes the soaking programme, delivering a wide jet or a soaking mist and wetting the box portions.

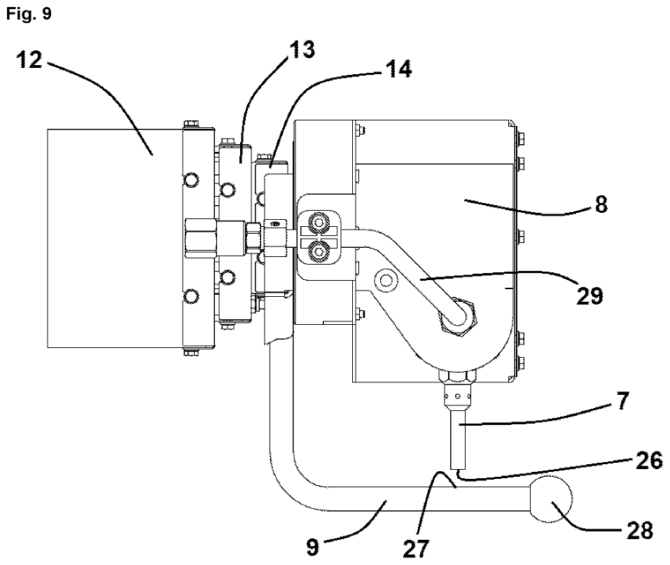

FIG. 9 shows a detail view of one side of the nozzle head of the inventive mobile washing robot 1 according to FIG. 1. The fluid is fed to the nozzle 7 via a high-pressure line 29.

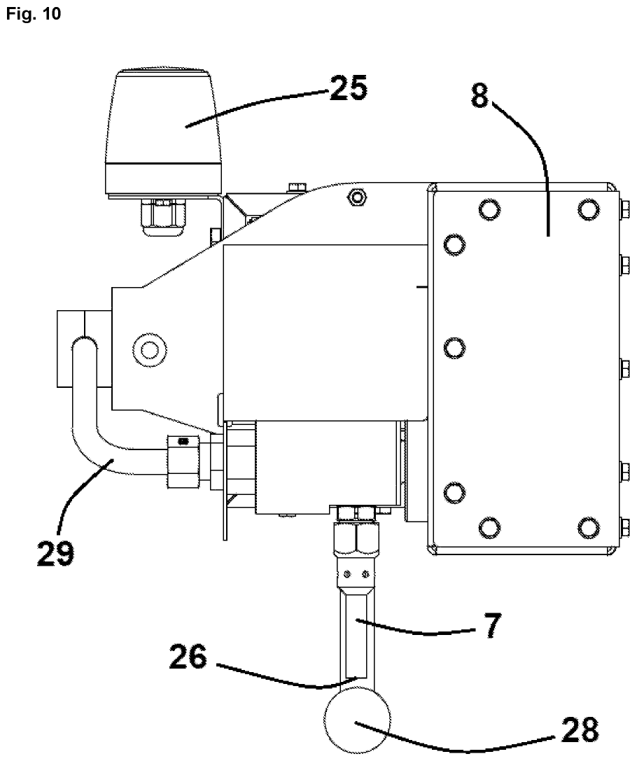

FIG. 10 shows a detail view of the front of the nozzle head 8 of the inventive mobile washing robot 1 according to FIG. 1.

All of the characteristics represented in the description, in the following claims and in the drawings, as considered either in themselves or in any combination with each other, may be deemed essential to the invention.

### LIST OF REFERENCE NUMERALS

1 washing robot
2 chassis
3 exchangeable battery
4 drive wheel
5 caster wheel
6 cleaning arm
7 nozzle
8 nozzle head
9 baffle device
10 telescopic arm
11 telescoping element
12 telescoping element
13 telescoping element
14 telescoping element
15 turret
16 hose reel
17 hose line
18 rear side
19 front side
20 guide roller
21 sensor
22 operating display
23 locking means
24 radar sensor
25 signal lamp
26 nozzle opening
27 baffle surface
28 injury protection
29 high-pressure line

1.-19. (canceled)

20. A mobile washing robot (1),
including a chassis (2),
including at least one drive mechanism,
including an undercarriage,
including at least one sensor (21) for travel path monitoring,
including at least one cleaning arm (6), wherein at least one cleaning arm (6) has at least one nozzle head (8) arranged thereon that has at least one nozzle (7), and
including at least one computer control unit,
characterised in that
the washing robot (1) has, in addition to the at least one sensor (21) for travel path monitoring, at least one further radar sensor (24) by means of which the dimensions of a stable area to be cleaned are automatically measured and/or an obstacle detection is automatically carried out, whereby data thus obtained are automatically made available to the computer control unit for calculating a position of at least one cleaning arm (6) and for calculating a travelling speed, a position of at least one nozzle head (8), a position of at least one nozzle (7), an activation and deactivation of at least one nozzle (7) and/or a flow rate of a fluid within at least one nozzle (7).

21. The washing robot (1) as claimed in claim 20,
characterised in that
at least one cleaning arm (6) is movably arranged on the chassis (2) and/or at least one nozzle head (8) arranged on a cleaning arm (6) is movably arranged on said cleaning arm (6) and/or at least one nozzle (7) arranged on a nozzle head

(8) is movably arranged on said nozzle head (8).

22. The washing robot (1) as claimed in claim 20,
characterised in that
at least one drive mechanism and/or at least one cleaning arm (6) and/or at least one nozzle head (8) and/or at least one nozzle (7) may be controlled by the computer control unit.

23. The washing robot (1) as claimed in claim 20,
characterised in that
at least one cleaning arm (6) consists of several parts and/or can be shortened and/or is foldable.

24. The washing robot (1) as claimed in claim 20,
characterised in that
at least one cleaning arm (6) is a telescopic arm (10) or a pantograph arm.

25. The washing robot (1) as claimed in claim 20,
characterised in that
the washing robot (1) has at least one guide roller (20).

26. The washing robot (1) as claimed in claim 20,
characterised in that
the washing robot (1) has a display and/or an operating panel.

27. The washing robot (1) as claimed in claim 20,
characterised in that
the washing robot (1) has high-pressure cleaning device and/or a connector for such a high-pressure cleaning device.

28. The washing robot (1) as claimed in claim 20,
characterised in that
the washing robot (1) has at least one soaking nozzle and/or at least one baffle device (9) for atomising a fluid jet of a nozzle (7).

29. The washing robot (1) as claimed in claim 20,
characterised in that
at least one drive mechanism is an electric drive or a pneumatic motor.

30. A method of cleaning a stable in which a mobile washing robot (1) is used which has a chassis (2), at least one drive mechanism, an undercarriage, at least one sensor (21) for travel path monitoring, at least one cleaning arm (6), wherein for delivering at least one fluid at least one cleaning arm (6) has at least one nozzle head (8) arranged thereon that has at least one nozzle (7), and a computer control unit,
characterised in that
the washing robot (1) has, in addition to the at least one sensor (21) for travel path monitoring, at least one further radar sensor (24) by means of which the dimensions of a stable area to be cleaned are automatically measured and/or an obstacle detection is automatically carried out, whereby data thus obtained are automatically made available to the computer control unit for calculating a position of at least one cleaning arm (6) and for calculating a travelling speed, a position of at least one nozzle head (8), a position of at least one nozzle (7), an activation and deactivation of at least one nozzle (7) and/or a flow rate of a fluid within at least one nozzle (7).

31. The method as claimed in claim 30,
characterised in that
for calculating the position of at least one cleaning arm (6) and for calculating the travelling speed, the position of at least one nozzle head (8), the position of at least one nozzle (7), an activation and deactivation of at least one nozzle (7) and/or a flow rate of a fluid within at least one nozzle (7), the computer control unit takes into account also manually entered data by a user, in addition to the data automatically provided by the at least one radar sensor (24).

32. The method as claimed in claim 31,
characterised in that
the manually entered data relate to at least one wall height to be cleaned and/or to the degree of soiling.

33. The method as claimed in claim 30,
characterised in that
the computer control unit uses the data available in order to calculate a position of at least one cleaning arm (6) that varies during the cleaning operation and a travelling speed that varies during the cleaning operation, a position of at least one nozzle head (8) that varies during cleaning, a position of at least one nozzle (7) that varies during cleaning, an activation and deactivation of at least one nozzle (7) that varies during cleaning and/or a flow rate of a fluid within at least one nozzle (7) that varies during cleaning.

34. The method as claimed in claim 30,
characterised in that
the surface to be cleaned is soaked with a fluid before the actual cleaning takes place, wherein the fluid to be dispensed for this purpose is dispensed through at least one soaking nozzle arranged on the washing robot (1).

35. The method as claimed in claim 30,
characterised in that
the surface to be cleaned is soaked with a fluid before the actual cleaning takes place, wherein the fluid to be dispensed for this purpose is dispensed through at least one nozzle (7) the fluid jet of which is atomised at a baffle device (9).

36. The method as claimed in claim 35,
characterised in that
the atomisation of the fluid to be dispensed is carried out by moving the nozzle head (8) and/or the nozzle (7) and/or the baffle device (9) into such a position that the fluid jet of the nozzle (7) atomises at the baffle device (9).

37. The method as claimed in claim 30,
characterised in that
the washing robot (1) employed is a washing robot (1) as claimed in claim 20.
